(19) United States
(12) Patent Application Publication
(10) Pub. No.: US 2004/0001218 A1
(43) Pub. Date: Jan. 1, 2004

(54) System and method for customizing an imaging device

(76) Inventor: Robert Douglas Christiansen, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/183,818

(22) Filed: Jun. 27, 2002

(51) Int. Cl. G06F 3/12; G06F 13/00; G06F 15/00

(52) U.S. Cl. 358/1.15

(57) ABSTRACT

A method and system for customizing an imaging device by electronically downloading a parser is provided. The method provides a computer executable methodology for downloading a dynamically customizable parser into the imaging device and employing a server in the imaging device to serve the downloaded parser to parse a data stream. The system provides a dynamically configurable system for parsing data. With the present system and method, a parser can be replaced or modified without having to physically replace hardware and/or firmware components.

### FIELD OF INVENTION

This invention relates to image developing technology, and more particularly concerns customizing an imaging device using a dynamically modifiable parser.

### BACKGROUND OF THE INVENTION

An imaging device, for example a printer, can receive data that includes print data (to be printed) and control data (to control a printer operation and/or output appearance). Control data can be distinguished from display data by, for example, parsing a tokenized control language that includes recognizable token sequences. A printer parser facilitates distinguishing print data from control data by recognizing token sequences in the tokenized control language and facilitates controlling printer operation and output appearance by associating actions with token sequences. Printer parsers are typically installed by inserting a read-only memory (ROM) into a printer. To create a ROM, printer parsers are coded in procedural languages (e.g., C, assembler), compiled into hardware specific executables, and then burnt into the ROM. Thus, updating a printer parser involved manually creating and changing a ROM, which mandates physical access to the printer. Furthermore, since the ROM was physically plugged into the printer, adapting a parser for a new hardware configuration and/or printer required extensive knowledge of the printer hardware and/or internals.

### SUMMARY OF THE INVENTION

The following presents a simplified summary of methods, systems, and computer readable media for customizing an imaging device. This summary is not an extensive overview and is not intended to identify key or critical elements of the methods, systems, and computer readable media or to delineate the scope of these items. It provides a conceptual introduction in a simplified form as a prelude to the more detailed description that is presented later.

The systems, methods, and computer readable media described herein concern customizing an imaging device with a parser that is electronically loaded into the imaging device. The parser is then served up as an applet in the printer to facilitate parsing input data to produce output data.

Certain illustrative example methods, systems, and computer readable media are described herein in connection with the following description and the annexed drawings. These examples are indicative, however, of but a few of the various ways in which the principles of the methods, systems, and computer readable media may be employed and thus are intended to include equivalents. Other advantages and novel features may become apparent from the following detailed description when considered in conjunction with the drawings.

### BRIEF DESCRIPTION OF THE DRAWINGS

FIG. 1 is a schematic block diagram of an example embodiment of a parsing system.

FIG. 2 is a schematic block diagram of an example embodiment of a parsing system, where the system includes a printer.

FIG. 3 is a schematic block diagram of an example embodiment of a system for printing a computer file.

FIG. 4 is a flow chart of an example embodiment of a computer implemented method for customizing a printer.

FIG. 5 is a flow chart of an example embodiment of a computer implemented method for selectively updating an input to a printer.

FIG. 6 is a flow chart of an example embodiment of a computer implemented callback method for manipulating a print stream and/or controlling a printer.

FIG. 7 is a flow chart of an example embodiment of a method for customizing a printer.

FIG. 8 is a schematic block diagram of an example embodiment of a set of filters and callbacks employed in real time parsing of a printer control language (PCL) data stream.

FIG. 9 is a schematic block diagram of an example embodiment of a printer that has been configured with a loadable Java PCL parser that interacts with a Java virtual machine and printer control logic.

FIG. 10 is a schematic block diagram of an example computing environment in which an example embodiment of a PDL parser can operate.

FIG. 11 is an example embodiment of a data packet for transmitting an electronically loadable parser in a computer communication.

FIG. 12 illustrates a portion of an example tokenized page description language.

FIG. 13 illustrates an example of a parse tree.

FIG. 14 illustrates an example imaging device.

### DETAILED DESCRIPTION OF THE ILLUSTRATED EMBODIMENTS

Example methods, systems and computer readable media are now described with reference to the drawings, where like reference numerals are used to refer to like elements throughout. In the following description, for purposes of explanation, numerous specific details are set forth in order to facilitate a thorough understanding of the methods, systems and computer readable media described herein. It may be evident, however, that the methods, systems and computer readable media can be practiced without these specific details. In other instances, well-known structures and devices are shown in block diagram form in order to simplify the description.

As used in this application, the term “printer component” refers to a printer related entity, either hardware, firmware, software, a combination thereof, and/or software in execution. A printer component can be, but is not limited to being, a process running on a processor in a printer, a processor in a printer, an object resident in a printer, an executable in a printer, a thread of execution in a printer, and a mechanical element in a printer. One or more printer components can reside within a printer, and one or more printer components can similarly reside within a process and/or thread of execution. It will be appreciated that “printer component” is an exemplary term and that discussions related to the term may also apply to other types of imaging devices such as copiers, facsimile devices and other image reproducing devices.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer, printer or other electronic device to perform functions, actions and/or behave in a desired manner. The instructions may be embodied in various forms such as routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer and/or printer component and/or distributed between two or more communicating, co-operating, and/or parallel processing computer and/or printer components and thus can be loaded and/or executed in serial, parallel, massively parallel, and other manners.

“Computer file”, as used herein, refers to a collection of related items including, but not limited to, characters, bytes, strings, bits, bitfields, and so on that can be stored on a computer, transmitted between computers and/or printed by a printer, for example.

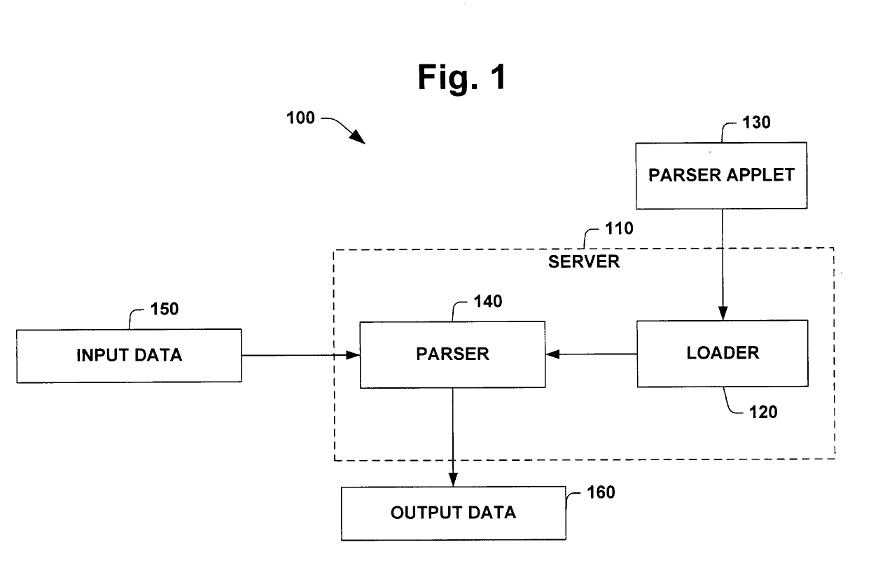

Referring initially to FIG. 1, an exemplary printer parsing system 100 is illustrated. The system 100 includes a server 110 and a loader 120 that loads an electronically loadable, dynamically installable, removable, modifiable parser applet 130 into the server 110. The server 110, loader 120, and parser applet 130 can be implemented as software. The loader 120 receives the parser applet 130 electronically via, for example, one or a series of computer communications and establishes the parser applet 130 as a dynamically installable, removable, modifiable parser 140 in the server 110. The parser 140 can then be served as an applet by the server 110 to facilitate processing an input data 150 into an output data 160. By dynamically loading different parsers into the server 110, a printer or other imaging device can be dynamically configured to generate different output data 160.

The loader 120 receives the loadable parser applet 130 in a computer communication, which can be, for example, a network transfer, a file transfer, an applet transfer, an email, a hypertext transfer protocol (HTTP) message, a datagram, an object transfer, and so on. A computer communication can occur across, for example, a wireless system (e.g., IEEE 802.11), an ethernet system (e.g. IEEE 802.3), a token ring system (e.g., IEEE 802.5), a local area network (LAN), a wide area network (WAN), a point to point system, a circuit switching system, a packet switching system, and so on.

With the parsing system 100, rather than burning a read only memory (ROM), gaining physical access to a printer and manually installing the ROM, a dynamic customization or configuration system can be produced. For example, the loadable parser applet 130 can be implemented in software, communicated across a network to the loader 120, and installed in the server 110 without a manual operation being performed at the server 110 site. Furthermore, the parser applet 130, after loading as the parser 140, can subsequently be dynamically modified by one or more signals. By implementing the parser 140 in software derived from a loadable parser applet 130 that was programmed in a web centric, object oriented programming language, the functions performed by the parser 140 can be dynamically customized. Dynamic customization facilitates accurate, efficient processing of input data 150 into output data 160. Furthermore, because the parser 140 is software rather than an executable loaded in a ROM, limitations on the number of parsers available on a system due to the number of physical ROM slots are mitigated. Similarly, limitations due to physical access requirements in ROM systems are mitigated.

The server 110 may be, for example, a webserver, a browser, and/or a chailet server (which is described in greater detail below). The server 110 serves up (e.g., provides operating system-like functions for) applets and/or chailets that are supported by a server 110 rather than being supported by an operating system. By way of illustration, the server 110 can acquire resources, manage memory, provide control services, handle communications, and the like for applets. Thus, the server 110 simplifies programming a loadable parser applet 130 in a manner that is independent of operating system and/or hardware specifics. Since the server 110 can handle multiple applets, the loader 120 can dynamically load one or more parser applets 130, which in turn facilitates customizing the functionality of a printer when transforming the input data 150 to the output data 160.

The parser 140 can be, for example, an applet. An applet is designed to be executed inside another application, frequently referred to as the server for the applet. Unlike an application, applets are not executed directly by an operating system and thus rely on their application, or server, for operating system-like functions (e.g., resource acquisition, resource management). Applets often run in web browsers, which may include a Java virtual machine for interpreting Java applets. Applets tend to be small in size and are platform (e.g., hardware, operating system) independent, which makes them suitable for use in Internet applications. Thus, in one example, the loadable parser applet 130 is a Java applet that is loaded from a webserver into the server 110 by the loader 120.

Java is an object oriented programming language with web centric features that make it suitable for writing applets and/or chailets that can be distributed across and/or run across networks like the Internet. Java code is compiled into platform (e.g., hardware, operating system) independent byte code that is then executed on Java virtual machines (VMs), which include a Java interpreter and a run time environment. Thus, in one example, the loadable parser applet 130 is compiled into Java byte code that is loaded by the loader 120 and then run by a virtual machine in the server 110.

By providing the operating system and hardware independent environment, the server 110 reduces the conceptual complexity of the parser 140 and thus lowers the sophistication and/or programming experience required to program a parser 140. For example, a parser programmer can focus on the language to parse and the actions to perform in response to parsing events (e.g., receiving a valid token sequence in input data 150) rather than focusing on hardware and/or operating system issues associated with the platform on which the parser 140 will run. This facilitates producing smaller, more portable parsers in a timely fashion by a larger set of programmers.

The input data 150 can include, for example, print data and control data, where the print data represents what is to be printed and the control data concerns, for example, how the print data will be displayed and/or how printer components involved in printing the print data should behave. The control data can include elements of a page description language, for example a tokenized language, where token sequences represent desired actions like, add print data, remove print data, change print data, change printer component state, and so on. In one example, the parser 140 processes control languages including, but not limited to, PCL 3, PCL 4, PCL 4e, PCL 5, PCL 5c, and PCL 5e.

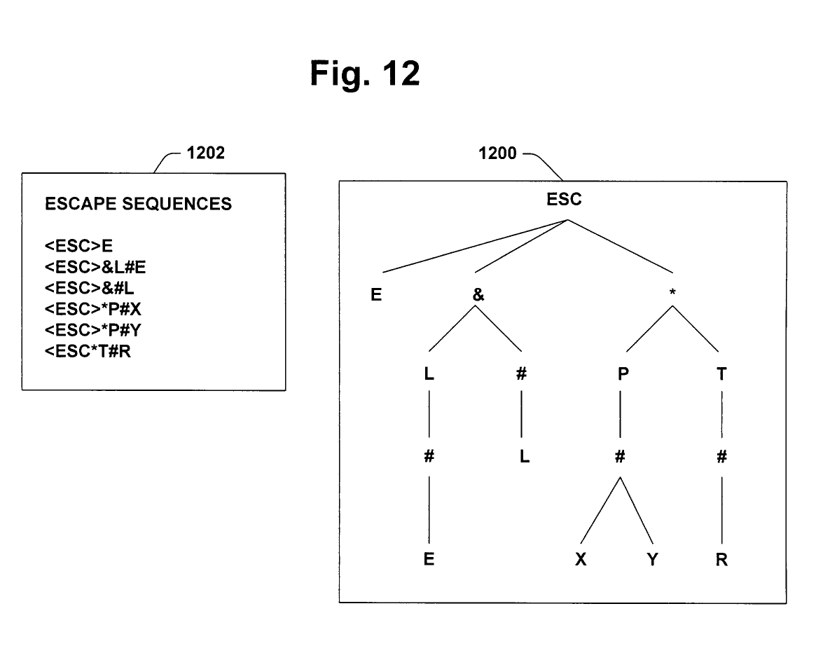

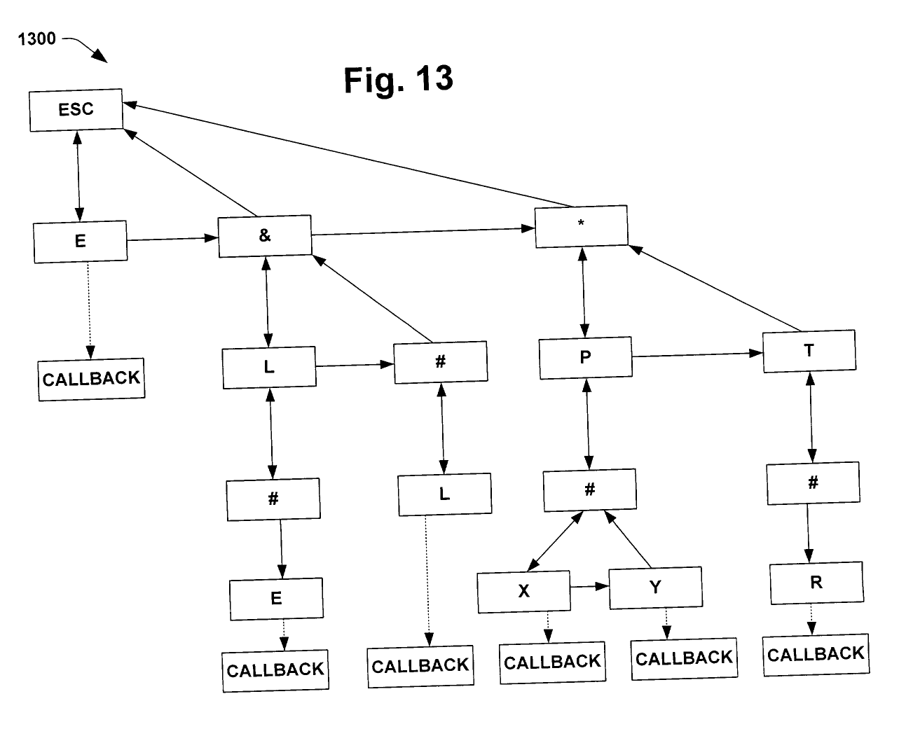

To facilitate recognizing token sequences and taking desired actions in response to token sequences, the parser 140 can include a parse tree (see FIGS. 12, 13), an input parser, and one or more callbacks. Parsing a tokenized language is described in more detail in association with FIGS. 12 and 13. While the parser 140 may be served as an applet, it may also be served as a chailet. Similarly, the loader 120 may be an applet and/or chailet.

A chailet is a Java program that runs on a chailet server (a server that serves chailets) to carry out specific functions like performing computations based on input from a remote device. Chailets can be loaded dynamically onto a chailet server. While an applet is dynamically loaded across a network and runs inside a browser, a chailet is a Java program that is dynamically loaded across a network but runs inside a chailet server. Whereas applets have a predefined set of functions (e.g., init, start, run, stop, destroy), chailets allow programmers to write additional methods that can be dynamically invoked at run time from a browser or from another chailet. Applets can be embedded inside a chailet.

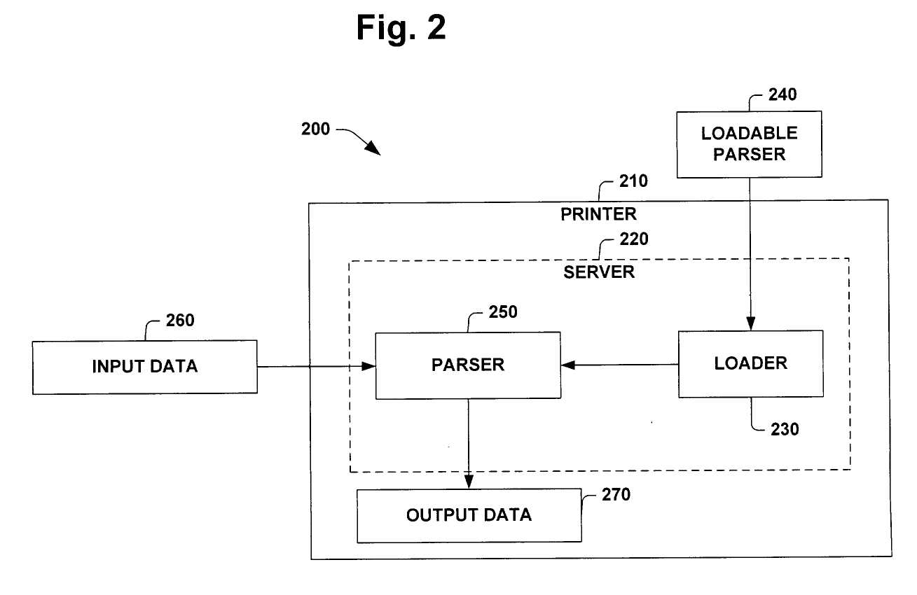

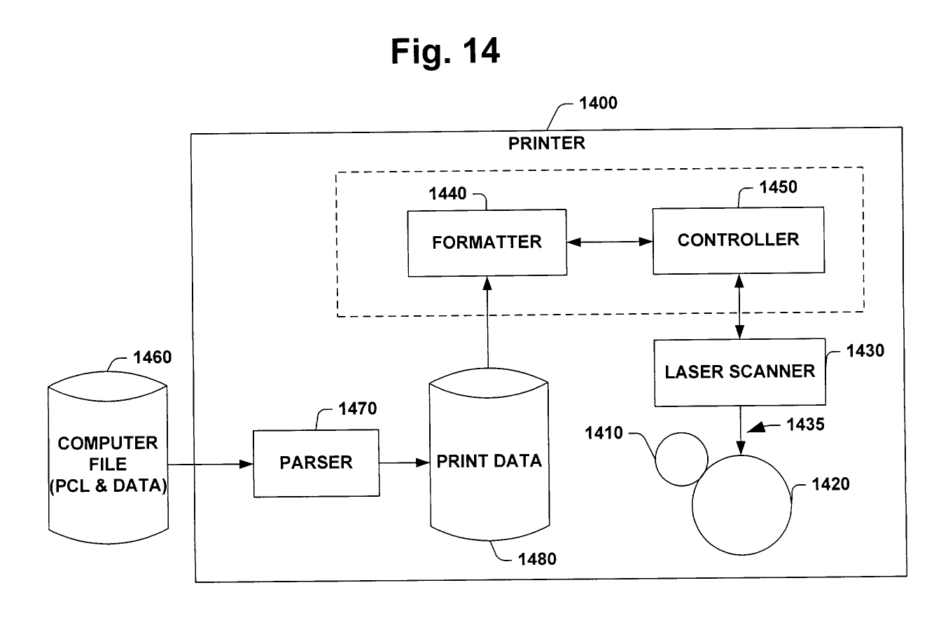

Referring now to FIG. 2, an exemplary imaging system 200 is illustrated. The system 200 parses an input data 260 and produces an output data 270. The system 200 includes a printer 210, a server 220, and a loader 230 that loads an electronically loadable parser 240 into the server 220 as a dynamically modifiable parser 250. The server 220, loader 230, loadable parser 240, and parser 250 can be implemented as software. The loader 230 receives the loadable parser 240 in one or more computer communications. The server 220 may be for example, a webserver, a browser, and/or a chailet server. With the server 220 and the parser 250 residing inside a printer 210, an input data 260 can be parsed by the parser 250 to produce an output data 270 that may then be presented to one or more downstream printer components for printing. The printing components can include, but are not limited to, a formatter that converts the output data 270 into a stream of binary print data that is an electronic representation of an imaged print, and a controller that supplies the binary print data to a laser scanner. For further examples of downstream printer components, see FIG. 14.

In one example, the system 200 is an imaging device that prints a computer file. The system 200 includes the server 220 that can run one or more applets. The applets can include, but are not limited to, one or more parsers 250, and one or more loaders 230. It is to be appreciated that the server 220 could run two or more parsers 250 substantially in parallel to facilitate selective, customizable parsing of the input data 260 into the output data 270. The imaging device can also include a parser loader 230 that can, under programmatic control, load into the server 220 one or more loadable parsers 240 that are received via computer communications.

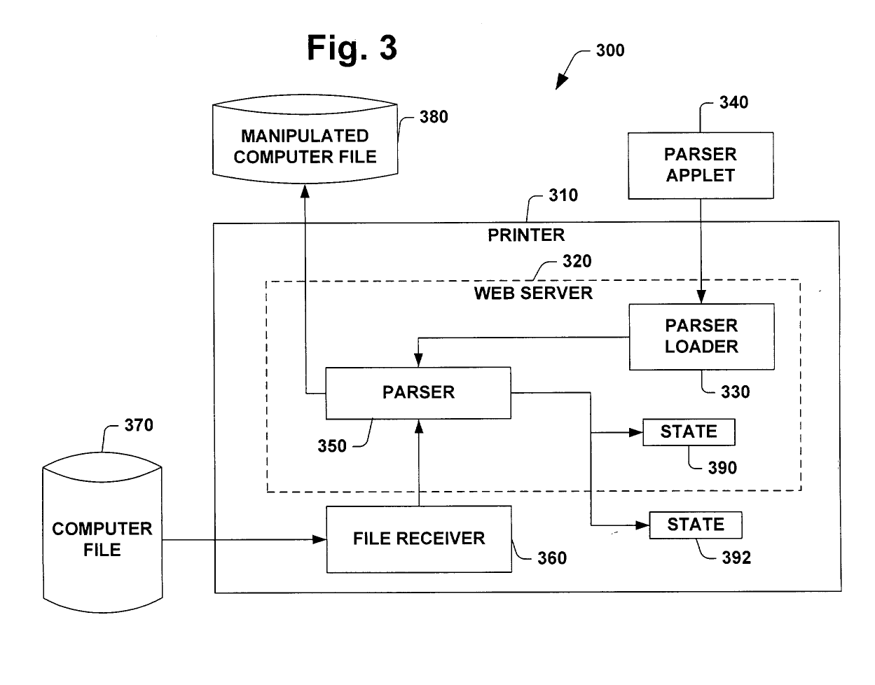

Turning now to FIG. 3, an exemplary system 300 for printing a computer file 370 is illustrated. The system 300 includes a customizable printer 310. The customizable printer 310 includes a server 320 for running applets. The server 320 can be, for example, a webserver, and/or a chailet server. The server 320 hosts a parser loader 330 that receives a loadable parser applet 340 in one or more computer communications and installs the loadable parser applet 340 in the server 320 as a dynamically configurable, loadable, unloadable, parser 350. The customizable printer 310 may also include a file receiver 360 that accepts a computer file 370 and presents it to the parser 350 to facilitate producing a manipulated computer file 380. Additionally, the webserver 320 may include a state 390. The state 390 can be embodied in, for example, software, firmware, hardware, and/or a collection thereof. State 390 records the condition of and/or controls the operation of the webserver 320 and/or one or more applets loaded in the webserver 320. Similarly, the customizable printer 310 may include a state 392. The state 392 can be embodied in software, firmware, hardware and/or a combination thereof. The state 392 records the condition of and/or controls the operation of the printer (e.g., online, offline, out of paper, out of toner).

The parser 350 manipulates the state 390 and/or the state 392 based, at least in part, on control data and/or print data received in the computer file 370. For example, a printer control language token sequence parsed by the parser 350 may cause the parser 350 to update the state 390 to indicate that the webserver 320 is currently processing a first computer file 370. Thus, the parser 350 may not be available for parsing another file until the first file is completed and the completion is reported in the state 390. Similarly, the parser 350 can manipulate the state 392 to indicate, for example, that memory in the customizable printer 310 is fully allocated. As such, the customizable printer 310 should not accept any more computer files 370 for parsing until portions of the memory are freed and it is reported in the state 392.

In another example, the parser 350 manipulates the state 390 and/or the state 392 by making one or more simple network management protocol (SNMP) “get” and/or “set” calls. For example, the parser 350 may receive a printer control language token sequence that indicates that a certain action is desired. Before engaging in the action, the parser 350 may perform an SNMP “get” from state 392, evaluate the state 392, and then perform an SNMP “set” on state 390 to indicate that the parser 350 is engaging in a particular activity.

In another example, the parser 350 takes the computer file 370, manipulates it by performing actions including, but not limited to, adding, removing, and changing printer data, and produces a manipulated computer file 380. While the manipulated computer file 380 is illustrated external to the webserver 320 and the printer 310 in FIG. 3, it is to be appreciated that the manipulated computer file 380 may be passed internally within the server 320 and/or printer 310 to downstream applets residing in the webserver 320 and/or printer components residing in the printer 310. However, the parser 350 may produce the manipulated computer file 380 and make it available to external printer components to facilitate distributed processing of computer files 370.

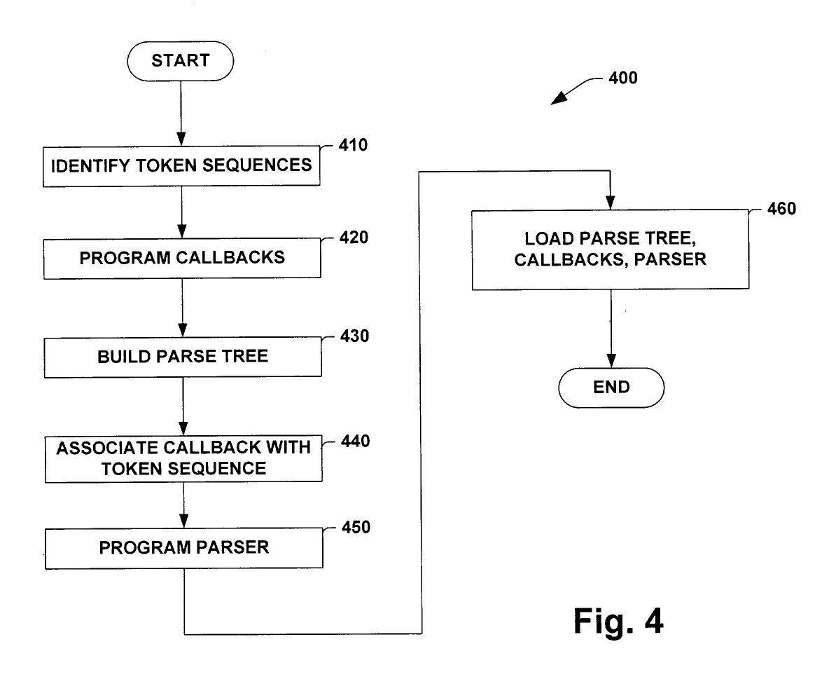

In view of the exemplary systems shown and described herein, exemplary methodologies will be better appreciated with reference to the flow diagrams of FIGS. 4 through 7. While for purposes of simplicity of explanation the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional blocks that are not illustrated. In one example, methodologies are implemented as computer executable instructions and/or operations that are stored on computer readable media including, but not limited to, an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, one or more processing and decision blocks can be implemented in functionally equivalent circuits like a digital signal processor (DSP), an application specific integrated circuit (ASIC), and the like.

A flow diagram does not depict syntax for any particular programming language, methodology, or style (e.g., procedural, object-oriented). Rather, a flow diagram illustrates functional information that one skilled in the art may employ to program software, design circuits, and so on. It is to be appreciated that in some examples, program elements like temporary variables, routine loops, and so on are not shown.

With reference to FIG. 4, an exemplary methodology 400 is illustrated for customizing a printer, which may also apply to other imaging devices. At 410, one or more printer control language token sequences are identified in a language in which printer input data may be supplied. Token sequences represent instructions to the printer to take desired actions and may be embedded in various parts of the printer input data. For example, one or more escape sequences (see, for example, FIGS. 12 and 13), may be defined in a printer control language. These escape sequences can indicate that certain actions are to be performed on print data included in a file in which the escape sequences are found. For example, an escape sequence may be employed to change the width, color, size, shape, and so on of printed characters. Furthermore, an escape sequence may be employed to perform actions like adding a print character, removing a print character, changing a print character (e.g., lower case to upper case), and so on.

At 420, one or more callback routines are programmed to perform the desired actions associated with various token sequences. It is to be appreciated that callback routines can be programmed at a variety of times including on an as-needed basis to facilitate customizing a printer. The callback routines can perform various functions. For example, if a token sequence instructs that a print character is to be deleted, a callback routine could be programmed to accept the print character in an input stream but not place the character in an output stream. Similarly, if the escape sequence indicated that the case of a character was to be changed, then the callback routine could accept a lower case character from an input stream and place a corresponding upper case character in an output stream.

At 430, a parse tree is built that implements the definition of valid token sequences. A parse tree is a convenient data structure for identifying strings of characters to which syntactic and/or semantic meaning can be attributed. A parse tree for a tokenized language can be built by identifying a token identifying character (e.g., “ESC”) and establishing that character at the root node of the parse tree. Although this application refers to American Standard Code for Information Interchange (ASCII) characters (e.g., “ESC”), it is to be appreciated that the example systems and methods described herein can be employed in parsing computer files containing other characters including, but not limited to, extended binary-coded decimal interchange (EBCDIC) characters and Unicode characters, for example.

Nodes that descend from the root node identify valid sequences, with the sequences terminating at leaf nodes. With the parse tree, received input data can be identified as a token sequence if characters from the input data lead to a traversal of the parse tree that ends at a leaf node. A parse tree traversal can be performed, for example, by recognizing the token identifying character, establishing a pointer to the root node, and then selectively stepping down the tree by advancing the pointer to nodes that match the characters in the input data sequentially. When a character in the input data does not continue a valid sequence of nodes in the tree, then the input data is not a valid token sequence as defined by the parse tree. The pointer can then be reset when another token identifying character is encountered. Also, when the pointer advances to a leaf node, then a valid sequence has been encountered. At this point, as described later, an action can be performed based on which sequence was encountered.

An exemplary parse tree is found in FIG. 13 where each node represents one character from a token sequence. When a parse tree traversal lands on a leaf node, a particular escape sequence has been identified and one of the callbacks programmed at 420 can be invoked. At 440, one or more of the programmed callbacks can be associated with a token sequence by relating a parse tree leaf node with the one or more callbacks. This relation can be viewed in FIG. 13 where pointers to callback routines have been established at the leaf nodes of the parse tree. With this association, on demand invocation of a callback can be performed when a token sequence is identified. While a parse tree is illustrated in FIG. 13 and discussed in FIG. 4, it is to be appreciated that other data structures associated with parsing (e.g., table, file, array) can be employed with the method 400.

With further reference to FIG. 4, a parser is programmed at 450. The parser can take advantage of the parse tree of 430 and the callbacks of 420 since the callbacks have been associated with the leaf nodes in the parse tree. In one example, the parser is coded in a web centric, object oriented programming language that allows the parser to be electronically transmitted to one or more devices (e.g., printers) via computer communication signals. For example, the parser can be written in Java. The parser can be programmed to accept input data, scan the data to find valid token sequences, and invoke appropriate callbacks when sequences are encountered. With a custom programmed parser, the print operation of a printer can be controlled to behave in a desired manner, thereby customizing the printer.

At 460, the printer is customized by electronically loading the parse tree, callbacks, and parser, by one or more computer communications, into a server in the printer. While FIG. 4 illustrates one load of a parse tree, callbacks, and parser into a server and/or a printer, it is to be appreciated that a printer can be customized with one or more parsers.

Since a printer can be customized by electronically loading a parse tree, callbacks, and parser, it may be desired to verify that the parse tree, callbacks, and/or parser will not create security concerns on a printer into which they are loaded. Therefore, the method 400 can be extended by, for example, verifying the parser, callbacks, and/or parse tree for issues like viruses, endless loops, null memory references, and so on. Based, at least in part, on the result of a verification, the parse tree, callbacks, and/or parser are selectively loaded into a printer. For example, the verification may establish a level of trust for a parse tree, callbacks, and/or parser. Then, based on this level of trust, a printer may determine whether to accept a parse tree, callback, and/or parser presented to the printer for loading. By way of illustration, a first printer that can be easily reset and on which few, if any, sensitive documents are printed, may accept a parser with a first level of trust established through verification. Alternatively, a second printer that is more difficult to reset and/or that deals with more sensitive documents may only accept a parser with a second level of trust indicating a higher degree of trust established through verification.

The input received at a printer customized in accordance with the method 400 may include, for example, one or more printable elements (e.g., printable characters) and one or more token sequences (e.g., escape sequences). The input can be dynamically parsed, for example, on a stream oriented basis, which facilitates traversing a parse tree. When the parse tree traversal yields a recognition of a valid token sequence by, for example, arriving at a terminal leaf node, then the parser can selectively invoke a callback associated with the terminal leaf node. Actions that can be performed when such a callback is invoked include, but are not limited to, adding, removing, and/or changing a printable element. Furthermore, the actions can include, but are not limited to, adding, removing, and/or changing one or more token sequences.

By way of illustration, a callback may be invoked when a first escape sequence is identified (e.g., <ESC>E). Assume that in one version of a printer control language “<ESC>E” indicates that a form feed should be generated. However, subsequent modifications to printers may have a requirement that the sequence <ESC>E be reserved for a different printer control function, for example, changing the state of a printer to offline. In a new version, <ESC>A now indicates a form feed. In this case, a callback can be programmed to change an <ESC>E sequence to an <ESC>A sequence. Then, when the parser encounters an <ESC>E sequence, it can invoke the associated callback to change the <ESC>E sequence to an <ESC>A sequence that will perform the desired form feed rather than the undesired change of state to offline.

Similarly, a callback invoked when a traversal arrives at a terminal node can selectively alter the operation of a printer. For example, an escape sequence may indicate that the printer should be taken offline. Therefore, the callback can update a printer component to indicate that the printer should be taken offline. Updates can include, but are not limited to, sending a signal, pulling an interrupt chain, generating an interrupt vector, altering a memory location, and updating a state object. The callback may perform the change by, for example, executing an SNMP “set” and/or “get” call.

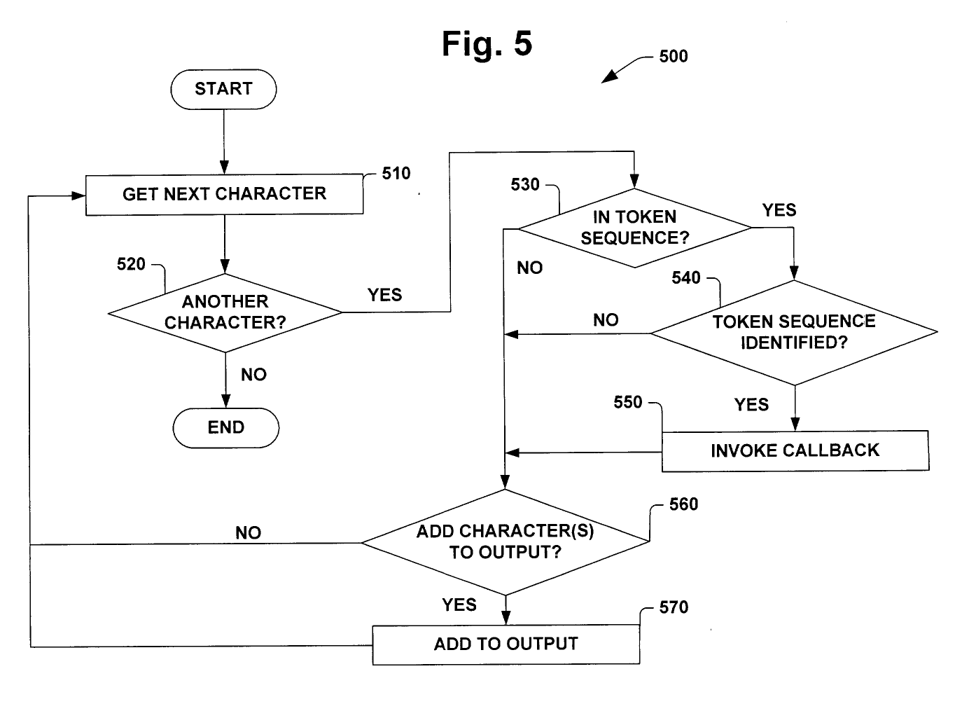

FIG. 5 illustrates an exemplary method 500 for parsing a token sequence and selectively invoking a callback to perform an action when a valid token sequence is identified. At 510, an attempt is made to retrieve a character. The character can come from, for example, an input stream, a file, a buffer, and the like. At 520, a determination is made concerning whether a character was retrieved at 510. If the determination is no, then method 500 concludes, otherwise processing proceeds to 530. While a decision block is illustrated at 520, it is to be appreciated that other methods (e.g., try/throw/catch, exception processing, interrupt processing) can be employed to read and verify character input.

At 530, a determination is made concerning whether the character initiates or continues a token sequence. For example, if the character is a token initializing character like the <ESC> character, then this would begin a token sequence. Similarly, if the character was the next character in a valid sequence (e.g., E following <ESC>), the determination at 530 would be yes. If the determination is no, then processing continues at 560. But if the determination at 530 is yes, then at 540, a determination is made concerning whether a valid sequence has been identified. For example, if the character is the last character in a valid sequence, then the determination at 540 would be yes. By way of illustration, as characters in a sequence are identified, a traversal of a parse tree (see e.g., FIGS. 12-13) can occur. When a character arrives that leads the tree traversal to a terminal node, then a valid sequence has been identified and the determination would be yes. If the determination at 540 is no, processing proceeds to 560, otherwise processing proceeds to 550.

At 550, a callback is invoked. The particular callback invoked depends, at least in part, on which token sequence was identified and which callback(s), if any, are associated with that sequence. While invoking a callback is illustrated at 550, it is to be appreciated that a variety of process invoking methods including, but not limited to, interrupt processing, remote procedure calls, and the like can invoke the processing desired when a specific token sequence is identified. The callback can perform actions including, but not limited to, adding characters to an input stream, removing characters from a print stream, altering a character (e.g., upper to lower case), and so on. Thus, at 560, a determination is made concerning whether to add one or more characters to the output produced by the parsing method 500. If the determination at 560 is yes, then at 570, one or more characters are added to the output. Otherwise processing continues at 510.

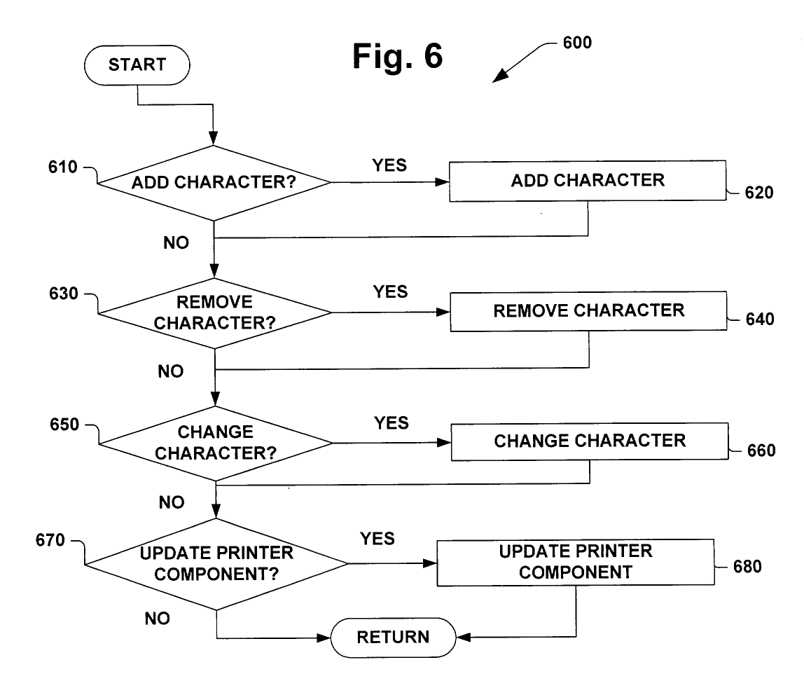

FIG. 6 illustrates an exemplary method 600 performed, for example, in a callback method. The method 600 provides examples of parsing processing that may be performed by a callback routine. For example, parsing can result in adding characters to a print stream, removing characters from a print stream, changing characters in a print stream and so on. Furthermore, when characters in a file are parsed, the characters may indicate that a state change should be made to a printer component. Thus, the decisions and processing steps illustrated in method 600 show sample parsing actions like adding/removing/changing characters and changing state. While method 600 illustrates four decisions and four possible actions, it is to be appreciated that a callback routine can perform a greater and/or lesser number of parsing actions.

At 610, a determination is made concerning whether to add one or more characters to a parser output. If the determination is yes, then at 620, the one or more characters are added. For example, to conserve space in an input, an escape sequence (e.g., <ESC>#L) may indicate that a number of similar characters, patterns, rays, etc. should be printed. Rather than placing, for example, 1000 “*” characters in an input, the sequence <ESC>1000* may be placed in the input. The callback method 600 could then be invoked when the sequence is encountered to place 1000 “*” characters in an output. The “#” character, as employed above (e.g., <ESC>#L) represents a number, either integer or floating point, that may have one or more digits. Thus, “#L” can represent character strings like “1000*”, “23i”, “1.23f”, and so on.

At 630, a determination is made concerning whether to remove one or more characters from an input. For example, an input may include a number of “padding” characters that format an input but that are not to be included in an output. Thus, an escape sequence (e.g., <ESC>P0X20) may identify a character to remove from an input. Thus, when the character corresponding to “0X20” is encountered in an input, it can be removed at 640. For “0X20” characters already placed in an output, the output may be reprocessed, for example, to remove appropriate characters. At 650, a determination is made concerning whether to change a character. If the determination is yes, then at 660 the change can be made. For example, an escape sequence (e.g., <ESC>LU) can indicate that a lower case letter is to be converted to an upper case letter. Thus, after receiving the sequence, one or more lower case letters can be changed in an output. For lower case characters already placed in an output, the output may be rewound, for example, to facilitate changing appropriate characters.

At 670, a determination is made concerning whether to update a printer component. For example, if a token sequence (e.g., <ESC>OL) is encountered, this can signal that a printer that receives the output should be taken offline after printing the output. If the determination at 670 is yes, then at 680 the printer component is updated.

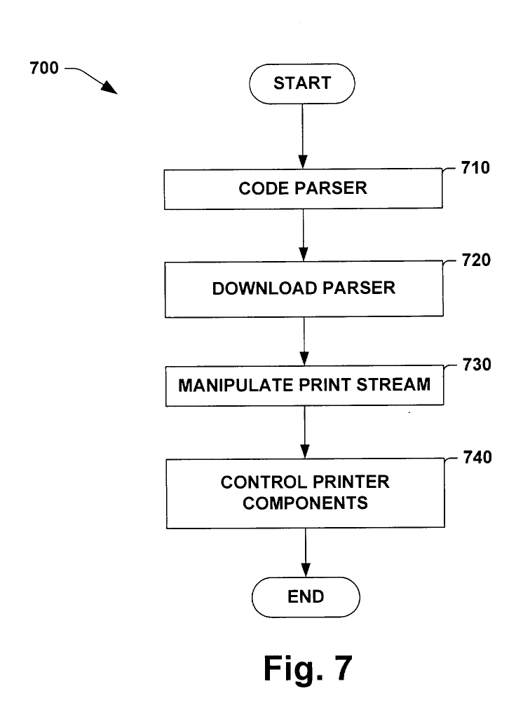

FIG. 7 is a flow chart that illustrates an exemplary method 700 for customizing a printer. At 710, a parser is coded. For example, a parser may be programmed in a web centric, object oriented programming language (e.g., Java) that facilitates electronically downloading the parser to servers for use as an applet. Coding the parser can include, but is not limited to, programming character retrieving and identifying logic, programming one or more data structures to facilitate identifying strings of characters, and programming event handling logic to perform when a character string is received. These parser components can be bundled together into a form that is suitable for transmission in computer communications.

At 720, the parser is downloaded to a printer that has a server. Rather than customizing the printer by receiving a new parser in an integrated circuit, the printer is customized by downloading the parser through a computer communication. It is to be appreciated that downloading the parser at 720 can involve sending the parser components (e.g., logic, data structures, callbacks) in one or more computer communications. Customizing a printer via a computer communication can lead to less expensive customization when compared, for example, to burning a new ROM and sending a technician to replace the old ROM.

At 730, the parser coded at 710 and downloaded at 720 provides custom parsing for the printer by manipulating input data into a desired output print stream. When the parser code is embodied in software, it is to be appreciated that the coding step 710 and downloading step 720 can be performed one or more times to facilitate customizing a printer to parse a variety of languages. Thus, the parsing at 730 can be customized one or more times for a printer. For example, a printer may download a parser on an as needed and/or as updated basis, although per file customization is possible.

At 740, the parser coded at 710 and downloaded at 720 provides custom control of one or more printer components. For example, printer components including, but not limited to, diagnostic lights, font selectors, tray selectors, and the like may be selectively controlled by the parser. The method 700 can be adapted, for example, by registering a parser with a printer manufacturer and/or printer component customization verifier. By way of illustration, a printer provider may program a printer, server and/or loader to accept registered parser applets and to reject unregistered parser applets. Thus, unless the parser applet contains, for example, a digital certificate, the printer, server, and/or loader may reject a parser offered for download, facilitating printer customization security.

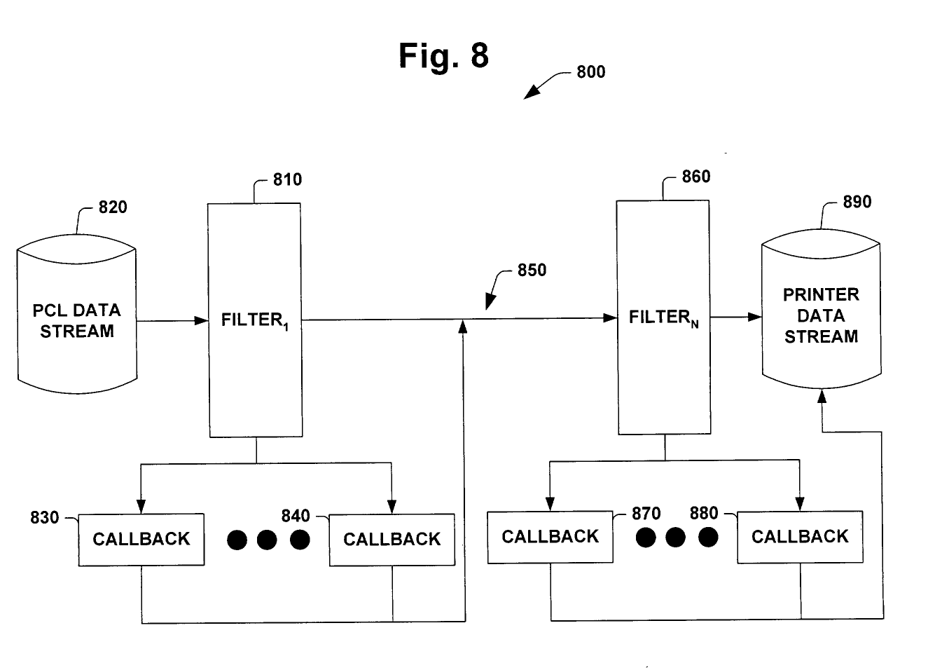

Turning now to FIG. 8, an exemplary system 800 that includes a plurality of filters (e.g., filter₁ 810 through filter_{N} 860) employed in manipulating a printer control language (PCL) data stream 820 to produce a printer data stream 890 is illustrated. Parsing is a process whereby phrases in a string of characters in a language are identified to facilitate applying meaning to the identified phrases. Parsing can be divided into lexical analysis and semantic processing, for example. Lexical analysis partitions strings into components (e.g., tokens) based, for example, on punctuation (e.g., # character). Semantic parsing involves determining the meaning of the string and/or tokens. Thus, while a parser may traverse a parse tree to facilitate lexical and/or semantic processing, a filter may employ alternative and/or additional means like pattern matching, table lookups, and the like to identify a token.

The PCL data stream 820 includes, for example, print data and control data (e.g., tokenized escape sequences). As the PCL data stream 820 is processed by filter₁ 810, one or more callbacks (e.g., 830 through 840) can be invoked to perform actions including, but not limited to, adding, removing, and changing data from the PCL data stream 820 to produce the intermediate data stream 850. Additionally, the filter₁ 810 may pass data from the PCL data stream 820 to the intermediate data stream 850 without invoking a callback.

The intermediate data stream 850 is then passed to filter_{N} 860 which passes the data to the printer data stream 890 and/or invokes one or more callbacks (e.g., 870 through 880) that manipulate the intermediate data stream 850. While two filters are illustrated in FIG. 8, it is to be appreciated that a greater and/or lesser number of filters can be employed in system 800. Furthermore, while the filters are illustrated operating in serial to produce one printer data stream 890, it is to be appreciated that the filters could operate substantially in parallel and produce two or more printer streams. The plurality of data streams could then be printed by one printer and/or distributed to two or more printers. Thus, a dynamic, reloadable, modifiable filter that facilitates customizing a printer can be employed in a first printer to provide customized parsing for one or more printers in data communication with the first printer.

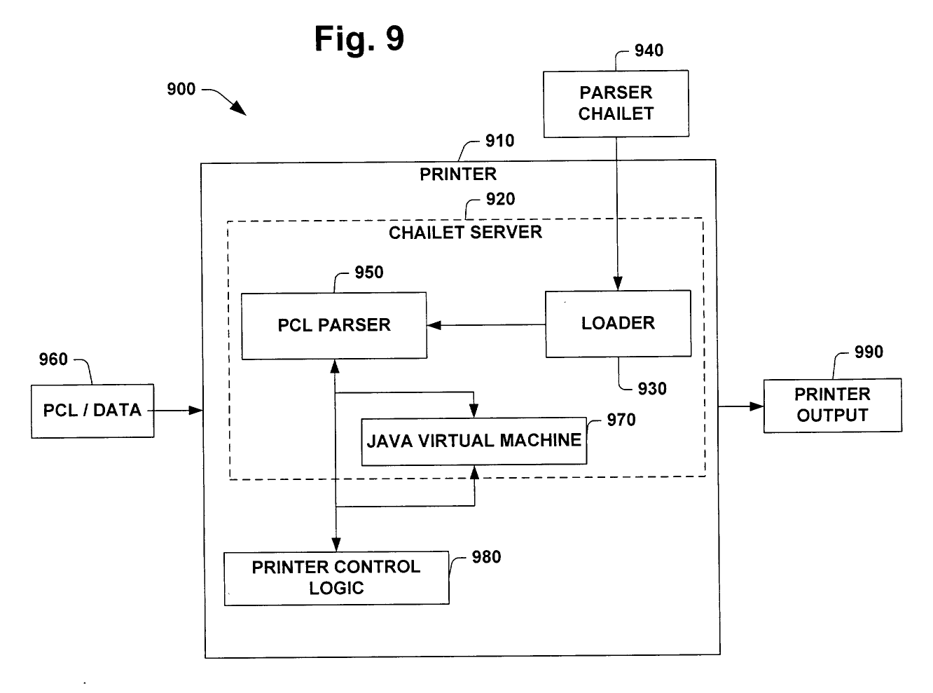

FIG. 9 illustrates an exemplary system 900 for producing a printer output 990 from a PCL/print data input 960. The printer output 990 can be, for example, a printed page. The system 900 includes a customizable printer 910 that has a chailet server 920. The server 920 employs a loader 930 to load a parser chailet 940 into the server 920 as PCL parser 950. The loader 930 can itself be a chailet. The parser chailet 940 can be programmed, for example, in Java. Thus, the server 920 includes a Java virtual machine 970 to service the PCL parser 950. Additionally, the printer 910 includes printer control logic 980 that controls printer components that regulate, for example, margins, fonts, print sizes, print location, print orientation, on-line status, and so on. As the PCL/print data 960 is processed by the PCL parser 950, the parser 950 and/or Java virtual machine 970 communicate with the printer control logic 980 to selectively control one or more printer components.

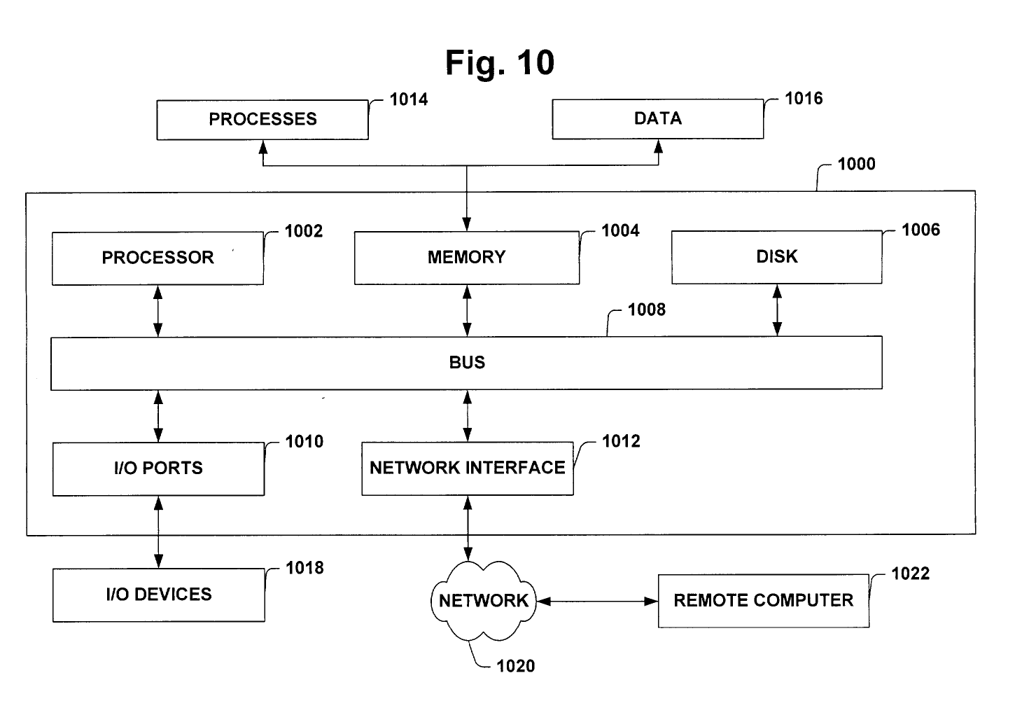

FIG. 10 illustrates a computer 1000 that includes a processor 1002, a memory 1004, a disk 1006, input/output ports 1010, and a network interface 1012 operably connected by a bus 1008. It is to be appreciated that a printer can include a computer, and thus the computer 1000 can reside within a printer. Executable components of the systems described herein may be located in a printer on a computer similar to computer 1000. Similarly, computer executable methods described herein may be performed in a printer on a computer similar to computer 1000. It is to be appreciated that other computers may also be employed with the systems and methods described herein.

The processor 1002 can have various forms including dual microprocessor and other multi-processor architectures. The memory 1004 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1006 can include, but is not limited to, devices like a magnetic disk drive, a floppy disk drive, a tape drive, a Zip drive, a flash memory card, and/or a memory stick. Furthermore, the disk 1006 can include optical drives like, a compact disk ROM (CD-ROM), a CD recordable drive (CD-R drive), a CD rewriteable drive (CD-RW drive) and/or a digital versatile ROM drive (DVD ROM). The memory 1004 can store processes 1014 and/or data 1016, for example. The disk 1006 and/or memory 1004 can store an operating system that controls and allocates resources of the computer 1000.

The bus 1008 can be a single internal bus interconnect architecture and/or other bus architectures. The bus 1008 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1000 interacts with input/output devices 1018 via input/output ports 1010. Input/output devices 1018 can include, but are not limited to, a keyboard, a microphone, a pointing and selection device, cameras, video cards, displays, and the like. The input/output ports 1010 can include but are not limited to, serial ports, parallel ports, IEEE 1394 ports, and USB ports.

The computer 1000 can operate in a network environment and thus is connected to a network 1020 by a network interface 1012. Through the network 1020, the computer 1000 may be logically connected to a remote computer 1022, from which a loadable parser may be received in a computer communication. The network 1020 includes, but is not limited to, local area networks (LAN), wide area networks (WAN), and other networks. The network interface 1012 can connect to local area network technologies including, but not limited to, fiber distributed data interface (FDDI), copper distributed data interface (CDDI), ethernet/IEEE 802.3, token ring/IEEE 802.5, wireless/IEEE 802.11 and the like. Similarly, the network interface 1012 can connect to wide area network technologies including, but not limited to, point to point links, and circuit switching networks like integrated services digital networks (ISDN), packet switching networks, and digital subscriber lines (DSL).

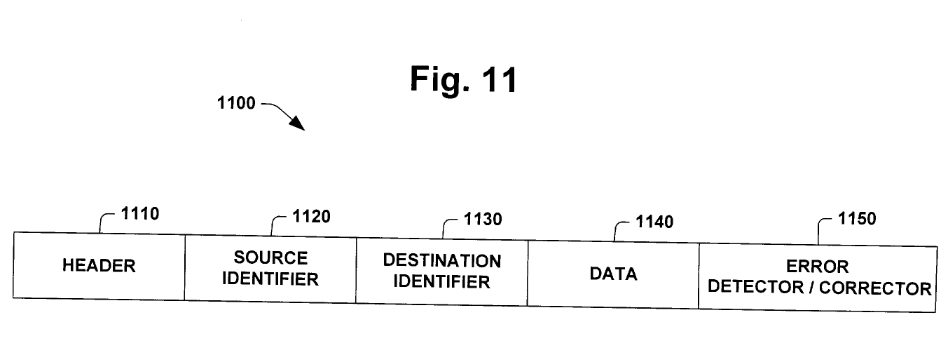

Referring now to FIG. 11, information can be transmitted, via a data packet 1100, between various printer and/or computer components associated with making a computer printout as described herein. An exemplary data packet 1100 is shown. The data packet 1100 includes a header field 1110 that includes information such as a length and type of packet. A source identifier 1120 follows the header field 1110 and includes, for example, an address of the printer and/or computer component from which the packet 1100 originated. Following the source identifier 1120, the packet 1100 includes a destination identifier 1130 that holds, for example, an address of the printer and/or computer component to which the packet 1100 is ultimately destined. Source and destination identifiers can be, for example, globally unique identifiers, URLs (uniform resource locators), path names, and the like. For example, the data field 1140 in packet 1100 includes various information intended for the receiving printer and/or computer component. The data field 1140 can hold, for example, all or parts of a parse tree, a loadable parser, and/or one or more callbacks. While a single data packet 1100 is illustrated, it is to be appreciated that one or more data packets 1100 may be employed to transmit a parse tree, a loadable parser, and/or callbacks to a printer for loading in the printer. The data packet 1100 ends with an error detecting and/or correcting field 1150 whereby a printer and/or computer component can determine if it has properly received the packet 1100. While six fields are illustrated in the data packet 1100, it is to be appreciated that a greater and/or lesser number of fields can be present in data packets employed to transmit a loadable parser to a printer, and that the order of the fields is not limited by the order illustrated.

FIGS. 12 and 13 facilitate understanding the parsing of a tokenized language (e.g., printer control language PCL). In a tokenized language, certain characters (e.g., escape) are employed to identify the beginning of a tokenized sequence. Thus, FIG. 12 illustrates six tokenized sequences 1202 that begin with the escape character. While identifying the beginning of a tokenized sequence is relatively straight forward (e.g., scan an input data stream until the start character is recognized), identifying the end of a token sequence can be relatively more difficult. To facilitate identifying the end of a token sequence, the set of valid sequences for a tokenized language can be arranged, for example, in a parse tree. When a start character is received, a tree traversal can be initiated that facilitates identifying valid sequences.

By way of illustration, the six escape sequences 1202 illustrated in FIG. 12 can be logically arranged in a tree 1200. Once an escape character is received, the next character(s) received will either advance the tree traversal (if the received character is in the tree) or cause the traversal to terminate if the character is not in the tree or if a terminal node (e.g., leaf) is reached. If the traversal reaches a leaf, then a valid escape sequence has been received. Receiving a valid sequence can trigger, for example, generating an event that performs an action based on having received the valid escape sequence. By way of illustration, receiving the sequence <ESC> E can trigger an event that causes a form feed in a printer. The form feed can be generated, for example, in a callback routine that is invoked when the valid sequence event occurs.

Traversing the tree 1200 can be facilitated by building a parse tree data structure. Thus, FIG. 13 illustrates a parse tree data structure 1300 that can be accessed, for example, by a parser tasked with recognizing tokenized sequences and performing actions associated with receiving a tokenized sequence. The parse tree 1300 therefore simplifies recognizing valid syntactic sequences in a data stream and providing semantic meaning to the sequence by facilitating selectively invoking software that performs actions associated with the sequence.

By loading one or more parsers, callbacks, and/or parse trees into a printer by computer communications, the systems, methods, and computer readable media described herein facilitate updating and/or customizing a printer. Employing the computer communication technique to customize a printer mitigates problems associated with burning a new read only memory (ROM), pulling a previously installed ROM, and replacing a pulled ROM with a new ROM.

Example systems, methods, and objects described herein may be stored, for example, on a computer readable media. The computer readable media can include, but are not limited to, an application specific integrated circuit (ASIC), a compact disc (CD), a digital versatile disk (DVD), a random access memory (RAM), a read only memory (ROM), a programmable read only memory (PROM), a disk, a carrier wave, a memory stick, and the like. Thus, an example computer readable medium can store computer executable components of a system for parsing input data. The components include, but are not limited to, a parsing component that is electronically loaded into a printer. The parsing component is delivered to the printer by a computer communication (e.g., network transfer, applet transmission). The system also includes a serving component that accepts the parsing component and then runs it as an applet. For example, the serving component performs operating system-like functions (e.g., memory access, resource allocation) for the parsing component that allow the parsing component to parse input data. Since the serving component can receive, load and/or unload one or more parsing components, the serving component facilitates parsing of input data by simplifying dynamic, real time parsing.

FIG. 14 is a simplified block diagram of an exemplary electrophotographic imaging device such as an electrophotographic printer 1400. The printer 1400 has printer components including, but not limited to, a charge roller 1410, a photoconductor drum 1420, a laser scanner 1430, a formatter 1440, and a controller 1450.

The charge roller 1410 charges the surface of a photoconductor (e.g., photoconductor drum 1420) to a predetermined voltage. The laser scanner 1430 includes a laser diode (not shown) that emits a laser beam 1435 onto the photoconductor drum 1420 to selectively discharge its surface. The laser beam 1435 is reflected off a multi-faceted spinning mirror (not shown) that reflects or ‘scans’ the laser beam 1435 across the surface of the photoconductor drum 1420 forming a latent electrostatic image corresponding to an image to be printed.

To form the latent electrostatic image, the formatter 1440 receives print data 1480 (e.g., a display list, electrographics, raster print data). The formatter 1440 converts the print data 1480 into a stream of binary print data that is an electronic representation of the image(s) to print and sends it to the controller 1450. The controller 1450 supplies the stream of binary print data to the laser scanner 1430 causing the laser diode to pulse in accordance with the data, thus creating the latent electrostatic image on the photoconductor drum 1420. Additionally, the formatter 1440 and controller 1450 exchange data necessary for controlling the electrophotographic printing process.

The exemplary printer 1400 also includes a parser 1470 that accepts a computer file 1460, parses it, and produces the print data 1480. Thus, the printer 1400 can be dynamically customized by electronically updating the parser 1470. By way of illustration, a first consumer may desire a first format for an image. Thus, the first consumer may generate a parser that is transmitted by a computer communication to the printer 1400 and loaded as parser 1470 that interprets PCL token sequences in the computer file 1460 to produce a print data 1480 that will have the desired properties. However, a second consumer may want a second format for the same image. Thus, the second consumer may generate a parser that is transmitted by a computer communication to the printer 1400 and loaded as parser 1470 that interprets the PCL token sequences in the computer file 1460 in a different way. While a single parser 1470 is illustrated in FIG. 14, it is to be appreciated that one or more parsers may operate on the computer file 1460 to produce print data 1480.

In one example embodiment, software means can dynamically parse a PCL data stream. The software means include, but are not limited to, a Java applet, a chailet, an object, a process, a thread, a program, and so on. In the example embodiment, communication means can convey a signal that encodes the software. The communication means include, but are not limited to computer communications, electronic communications, optical communications, and so on.

Although a printer is used in the above examples, it will be appreciated that the methods and systems of the invention will also apply to other imaging devices. Other imaging devices may include copiers, laser printers, inkjet printers, facsimile machines, and other devices that parse input data to generate output data.

What has been described above includes several examples. It is, of course, not possible to describe every conceivable combination of components or methodologies for purposes of describing the methods, systems, computer readable media and so on employed in an electronically loadable, dynamically modifiable, applet implemented, PCL parser. However, one of ordinary skill in the art may recognize that further combinations and permutations are possible. Accordingly, this application is intended to embrace such alterations, modifications, and variations that fall within the scope of the appended claims. Furthermore, to the extent that the term “includes” is employed in the detailed description or the claims, the term is intended to be inclusive in a manner similar to the term “comprising” as that term is interpreted when employed as a transitional word in a claim.

What is claimed is:

1. A customizable imaging device that generates image data from a parsed input data, the imaging device comprising:
one or more parser applets each for parsing a computer file into a parsed input data;
a server for running one or more of the parser applets; and
a parser loader for loading one or more of the parser applets into the server causing the imaging device to generate customizable image data based on which of the parser applets are loaded.

2. The imaging device of claim 1, wherein the one or more parser applets are embodied as dynamically loadable and unloadable applets.

3. The customizable imaging device of claim 1, further comprising:
a photoconductor for forming a latent electrostatic image;
a charge roller for charging a surface of the photoconductor to a predetermined voltage;
a laser scanner that emits a laser beam onto the surface of the photoconductor to form the latent electrostatic image; and
a software configured processing device, comprising:
a formatter for converting the printer input data into a stream of binary print data that is an electronic representation of an image to print; and
a controller that supplies the binary print data to the laser scanner.

4. The customizable imaging device of claim 1, further comprising a device state, where the device state is managed by one or more parser applets.

5. The customizable imaging device of claim 1, further comprising a server state, where the server state is managed by the one or more parser applets.

6. The customizable imaging device of claim 1, where one or more parser applets are programmed to perform at least one of a simple network management protocol get and set call.

7. A parsing system, comprising:
an electronically loadable parser;
a server that serves applets; and
a loader that receives the electronically loadable parser in one or more computer communications and loads the electronically loadable parser into the server.

8. The system of claim 7, where a parser loaded into the server can parse input data that comprises print data and control data, the control data comprising one or more token sequences of a tokenized page description language.

9. The system of claim 8, where the tokenized page description language is at least one of PCL 3, PCL 4, PCL 4e, PCL 5, PCL 5c and PCL 5e.

10. The system of claim 7, where the electronically loadable parser is software written in a web centric, object oriented programming language that facilitates serving the parser loaded into the server as an applet.

11. The system of claim 10, where the parser loaded into the server is one of an applet and a chailet.

12. The system of claim 10, where the web centric, object oriented programming language is JAVA.

13. The system of claim 7, where the parser loaded into the server is one of an applet and a chailet.

14. The system of claim 7, where the electronically loadable parser comprises a parse tree, one or more callbacks, and an input parser.

15. The system of claim 7, where the server is one of a webserver, and a chailet server.

16. The system of claim 7, where the server and the parser loaded in the server reside on an imaging device.

17. A method for customizing a printer, comprising:
identifying one or more printer control language token sequences for which an action is desired when the token sequence is identified in an input;
programming one or more callbacks to perform the desired action;
building a parse tree for defining the valid token sequences;
associating one or more callbacks with a token sequence by relating a parse tree leaf node with one or more callbacks;
programming a parser to facilitate traversing the parse tree based on a received token sequence and selectively invoking a callback associated thereto; and
loading, by a computer communication, the parse tree, the callbacks, and the parser into the printer to customize output generated by the printer.

18. The method of claim 17, further comprising:
verifying at least one of the parser and the callbacks; and
establishing a level of trust for at least one of the parser and the callbacks.

19. The method of claim 18, further comprising selectively loading the parser and the callbacks into the printer based on the level of trust.

20. The method of claim 17, further comprising:
receiving an input that comprises one or more token sequences and one or more printable elements;
dynamically parsing the input as it is received;
traversing the parse tree based on the dynamic parsing; and
selectively invoking one or more callbacks based, at least in part, on traversing the parse tree.

21. The method of claim 20, further comprising programming a callback to selectively update the input to produce an output by at least one of adding, removing, and changing at least one of the one or more printable elements and one or more token sequences.

22. The method of claim 20, further comprising programming a callback to selectively alter an operation of the printer.

23. The method of claim 22, wherein the programming alters the operation of the printer by updating a printer component.

24. The method of claim 22, where the programming includes making at least one of, an SNMP get call, and a SNMP set call.

25. A method for loading a parser into an imaging device, comprising the steps of:
downloading a parser as an applet into an imaging device; and
dynamically loading the parser in a software executable server within the imaging device to control parsing of print stream data.

26. The method of claim 25, further comprising dynamically unloading a previously loaded parser to be replaced by the downloaded parser.

27. The method of claim 25, further comprising dynamically loading a plurality of parsers within the server.

28. A system for customizing a printer, comprising:
software means for dynamically parsing a PCL data stream; and
communication means for receiving a signal encoding the software means into a printer.

29. The system of claim 28 where the software means for dynamically parsing the PCL data stream are dynamically customizable by a signal.

30. A data packet for transmitting a parser to a printer, the data packet comprising:
a first field that stores one or more computer executable parsing logic instructions; and
a second field that stores one or more computer readable data structure elements accessed by the parsing logic instructions to facilitate parsing data.

31. The data packet of claim 30, further comprising a third field that stores one or more computer executable callback instructions that are invoked by one or more parsing logic instructions to perform a desired action.

32. A computer readable medium storing computer executable components of a parsing system, the computer readable medium comprising:
a parsing component that can be received in an imaging device via a computer communication and loaded as an applet in the imaging device; and
a serving component that accepts the parsing component and serves the parsing component as an applet to facilitate dynamic customizable, real time parsing of an input data.
